(19) United States
(12) Patent Application Publication
(10) Pub. No.: US 2009/0106823 A1
(43) Pub. Date: Apr. 23, 2009

(54) System and method for remote access data security and integrity

(75) Inventor: Kristopher Durski, El Cerrito, CA (US)

Correspondence Address: REED SMITH, LLP, TWO EMBARCADERO CENTER, SUITE 2000, SAN FRANCISCO, CA, 94111, US

(73) Assignee: KDH Systems Inc., Berkeley, CA (US)

(21) Appl. No.: 11/975,844

(22) Filed: Oct. 22, 2007

(51) Int. Cl. H04L 9/32

(52) U.S. Cl. 726/4

(57) ABSTRACT

A system and method for locating and accessing remote data over a computer network that provides data security and integrity. The system includes at least one data server located in a first region, at least one data server located in a second region, a first indexing and network management server providing authentication services for the at least one data server located in the first region, a second indexing and network management server providing authentication services for the at least one data server located in the second region, and a central registration server providing authentication services to the first and second indexing and network management servers, including maintaining valid public key certificates for each indexing and management server. A local server is authenticated by its regional indexing and management server, which provides an authentication passport to indexing servers, on behalf of the local server. Thus, a local server can be authenticated to remote data servers and can request information from the remote data servers. Methods of authentication and data integrity are also provided.

### BACKGROUND OF THE INVENTION

1. Field of the Invention

The present invention relates generally to data access and data security, and more particularly, to a system and method for securely locating and accessing confidential information in a network environment.

2. Description of the Related Art

Presently, all healthcare providers collect Protected Health Information (PHI) that is used for patient identification at the point of service and billing. This includes, for example, the patient's name, address and insurance information. PHI data is stored locally in a computer system together with clinical data. Presently, there is no reliable mechanism to share the PHI data between healthcare providers. Each time a patient visits a new healthcare provider, the information must be reentered. Since the collection of PHI data is currently a manual process, there are risks for typographical errors that may result in difficulties in patient identification in the future.

To insure data integrity, healthcare providers generally assign each patient a unique identifier called a Medical Record Number (MRN) that is used to link various underlying medical records. This process works well as long as there is no exchange of information between different providers. Any attempt to exchange data between medical providers poses a risk of violating rules governing patient privacy and/or may result in the misidentification of data.

Another aspect that needs to be considered in healthcare information technology (IT) systems is the desire for a “patient centric” model for healthcare data. Existing IT solutions are provider centric and in most cases ignore patients as participants in the system. This approach violates the basic rights of each patient to control and verify his or her own data.

One approach to modernize healthcare IT systems is to provide a centralized data storage system, where each participant has access according to assigned roles. This model is widely used and is very successful on a small scale like a single hospital or at most a small number of hospitals. However, on a larger scale, including a global solution, this model is both economically impractical and not supportable from a public policy perspective. Any solution that creates a monopoly for a single vendor (including vendor lock-in i.e. a local monopoly) leads to quick technology obsolescence and higher prices. In addition, handling 6.5 billion patients speaking nearly 200 languages, obeying more than 150 legal codes and getting countries to agree on rules of implementation and funding seems like an impossible goal.

Therefore, what is needed is new information technology framework that can support the exchange of confidential PHI data between healthcare providers, while providing appropriate security and data integrity.

### SUMMARY OF THE INVENTION

The present invention is a system and method for locating and accessing remotely stored data, in a secure fashion, while maintaining data integrity.

In one embodiment, the present invention includes a system for secure remote data access, the system comprising at least one data server located in a first region; at least one data server located in a second region; a first indexing and network management server providing authentication services for the at least one data server located in the first region; a second indexing and network management server providing authentication services for the at least one data server located in the second region; a central registration server providing authentication services to the first and second indexing and network management servers, including maintaining valid public key certificates for each indexing and management server; wherein the at least one data server in the first region registers with the first indexing and network management server, and wherein the at least one data server in the second region registers with the second indexing and network management server; wherein when a data server in the first region requests information on a specific subject from other data servers in the system, the first indexing and management server locates any remote data servers having information on the subject, and provides an authorization passport for the at least one data server to access information on the remote data servers, the authorization passport verifying that the data server in the first region has been authenticated by the first indexing and management server, and that the first indexing and management server has been authenticated by the central registration server; and wherein the remote data servers provide the requested information on the specific subject to the data server in the first region.

The system may further cache the signed passport authorization for a predetermined period of time. The requested information may be identified by a unique Access ID and a unique Verify ID, the Access ID and Verify ID are generated as cryptographic hashes of ASCII strings of personal identifying data, and wherein each indexing and management server maintains an index of Access ID and Verify ID pairs for information stored on authenticated data servers in its region.

The system may transfer the requested information using a standard vocabulary to facilitate translation between different data storage systems. Each data server may assign a rank to each user of the system, a rank defining a data authorization classification level for each user, such that different users are allowed to access different levels of information. The requested information can be translated between systems using an XML object translation template to translate between vocabularies of different data servers.

The system preferably includes a plurality of regional indexing and management servers, and each regional indexing and management server authenticates a plurality of local data servers. To insure integrity of the system, each request for information may be logged and any personal identifying information is removed from any data sent from a remote data server.

In another embodiment, the present invention includes method for secure remote access to confidential data located on remote data servers, the method comprising: authenticating each data server in a system with a regional indexing and management server; authenticating each regional indexing and management server to a central registration server; storing indexes to information stored in each regional indexing and management server for each data server in its respective region; requesting information from remote data servers from a local data server; locating remote data servers having the requested information; generating an authorization passport from a local indexing and management server; sending the authorization passport to each remote indexing and management server of the remote data servers having the requested information, wherein each remote indexing and management server authenticates the passport authorization; providing the authorization passport to the remote data servers having the requested information; and sending the requested information to the local data server.

The method may further comprise assigning a rank to each user of the system, a rank defining a data authorization classification level for each user, such that different users are allowed to access different levels of information. The method may further comprise translating the requested information between systems using an XML object translation template to translate between vocabularies of different data servers.

To insure data integrity in the system, the method may further comprise logging each request for information to comply with privacy regulations, and removing any personal identifying information from the requested data before sending any data from a remote data server.

The present invention is particularly applicable to distributed medical information systems containing confidential patient medical records. In such an embodiment, the present invention includes a method for locating and accessing patient medical records located on remote data servers in a networked computer system, the method comprising: authenticating each data server in the system with a regional indexing and management server; authenticating each regional indexing and management server with a central registration server; creating an Access ID and a Verify ID for each patient in the system, the Access ID and the Verify ID are generated as cryptographic hashes of ASCII strings of personal identifying data, such each Access ID and Verify ID pair is unique for each patient; storing indexes to patient medical records stored in each regional indexing and management server for each data server in its respective region, wherein the indexes can be searched by the Access ID and the Verify ID of each patient; requesting remote patient medical records from remote data servers at a local data server; generating an authorization passport for the local data server at a regional indexing and management server; locating the requested remote patient medical records based on the stored indexes at each regional indexing and management server; sending an authorization passport to each regional indexing and management server having indexes to the requested remote patient medical records; signing the authorization passports at each regional indexing and management server; and sending the requested patient medical records from each remote data server to the local data server, based on the signed authorization passport.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram showing how a patient demographic server can interface with a patient data server at a hospital;

FIG. 2 is a block diagram of a process for uniquely identifying remote patient data;

FIG. 3 is block diagram illustrating a federated network system according to one embodiment of the present invention;

FIG. 4 illustrates an example of a passport, according to an embodiment of the present invention;

FIG. 5 illustrates an example of a message containing data, according to an embodiment of the present invention;

FIG. 6 illustrates how data is filtered according to access rights;

FIG. 7 illustrates an example of a user rank;

FIG. 8 illustrates an example of a data translation template; and

FIG. 9 is block diagram illustrating the process of a passport request.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

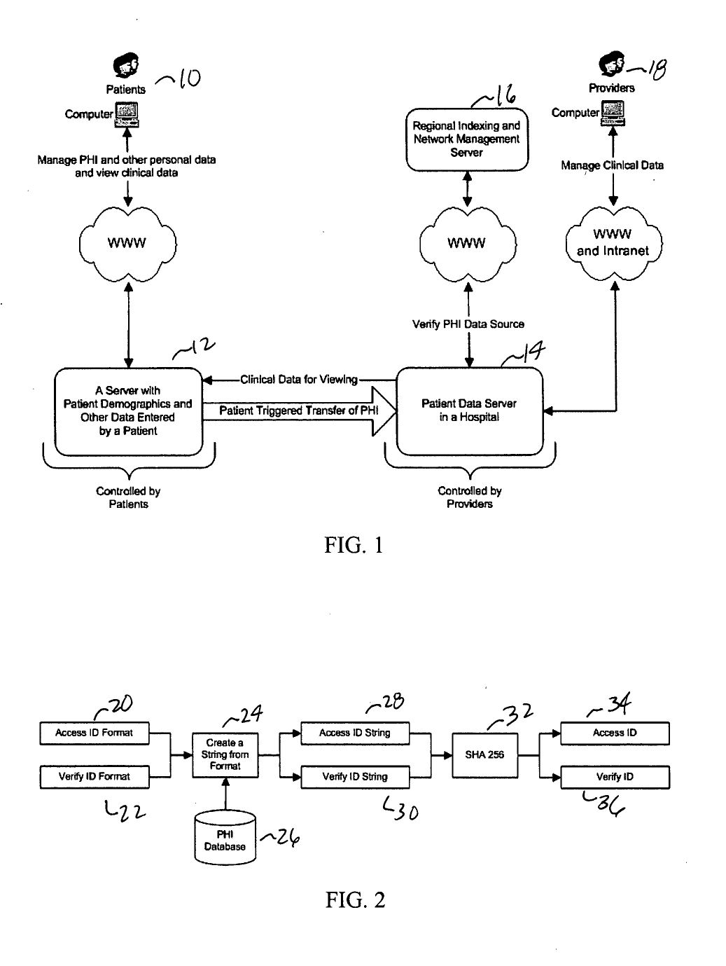

The present invention is a novel system and method for providing remote access to data (especially medical data), while providing data security and integrity. As illustrated in FIG. 1, the present architecture is patient centric and provides a solution for finding and retrieving patient records by the following strategies:
Putting data under control of the providers who author it
Avoiding duplication errors especially in data used for identification
Providing fully federated relationships between participants

As shown in FIG. 1, a computer network connects patients 10, hospitals and other healthcare providers 18. The network allows information to be shared across platforms. For example, patient 10 is able to enter and maintain his or her own personal patient demographic information via a patient demographic server 12. Each healthcare provider has at least one patient data server 14. The data in the patient data server 14 is controlled by the healthcare provider. Under control of the patient 10, patient demographic information may be uploaded to a patient data server 14, and clinical data may be viewed by the patient 10. The patient data server 14 is further linked to other provider servers, as discussed in further detail below.

By connecting patient data servers together, patient information can be located across health care providers, such that when a patient is examined at a new facility, the patient's prior medical history can easily be retrieved. However, since the patient data may be located in different locales, having different privacy rules and restrictions, it is necessary to control the distribution of the PHI data. Preferably, only those who author data have rights to edit the data, while others can only read the data. Those who author the data also have responsibility for its integrity, correctness and storage security.

The present invention utilizes the concept of “federated” computer systems. In a federated system, each server on a network acts autonomously in order to comply with local privacy laws, and hospital rules. However, each server can participate in a network at least on some level, and can exchange whatever information it is allowed to provide, although in some circumstances the provided information may be less than what was requested.

Each participating computer server of a federation of patient data servers has the responsibility for the proper release of fully identified data to a specific user such as healthcare provider, insurer, patient, etc. The specific release of information depends on roles, local policies and a robust authentication method. Even after a user has been properly identified, a full release is only allowed if authorized by a patient. In all other cases, de-identified releases are made, because they do not require patient authorization. Exchange of data between the servers of a federation is governed by their local policies regarding releases of de-identified information.

The present architecture assumes certain relationship between data and users of a federation and it anticipates transitional period when the status quo is part of the data storage and exchange model. In order to freely exchange clinical data without the risk of misidentification, the system has to be equipped with a technology that can generate globally unique identifiers based on PHI data.

The present invention provides for data security in order to protect PHI data from improper disclosure. Each patient needs a globally unique identifier, which is not easily discovered by third parties. As shown in FIG. 2, two security keys called an Access ID 34 and a Verify ID 36 are generated as cryptic hashes from ASCII strings. Specifically, ASCII strings are created (box 24) using an Access ID format 20 and a Verify ID format 22, and selected PHI data elements (from database 26). The Access ID String 28 and the Verify ID String 30 are then processed using a cryptographic algorithm, such as the SHA 256 algorithm 32. Foreign data would need to be translated into its ASCII equivalent and put into the correct specific format before processing. Also, each key is generated from different data elements, but must use those that are fixed in value such as last name, date of birth, mother's maiden name, social security number, gender, race, etc. This process generates an Access ID 34 and a Verify ID 36, which are unique identifiers of a patient.

As described herein, the present system assumes that it is less harmful to miss data rather than to find wrong data. Therefore, although the likelihood of key collisions for a hash of 256 bits is extremely low, dual-key searches are performed to eliminate any potential errors: first the Access ID 34 is used to find a patient record and then a Verify ID 36 is used to confirm the match. For example, the Access ID 34 could be a hash of a social security number and the Verify ID 36 could be a hash of a date of birth and last name. The likelihood that a social security number would have a typographical error that would create a match with a date of birth and a last name of somebody else is extremely low. Similarly, the likelihood of a collision of both keys for different data elements is also extremely low, or practically zero. By utilizing the Access ID and the Verify ID, PHI data can be located and retrieved across a distributed network, while providing a high level of data security.

Ideally, the present invention would support the connection of repositories and the exchange of medical information, regardless of the location of the PHI data servers. By utilizing a patient unique ID, the patient medical records can be located anywhere on the system, even in remote servers. Federated systems that span beyond a single country, however, have to be able to accommodate multi-language and multi-policy models. In such an environment, the servers could be grouped in policy and/or language clusters. Each cluster is then in turn managed by a single regional Indexing and Network Management Server (block 18, FIG. 1). All regional indexing servers are registered with a central server to provide visibility of all clusters to all members of a federation.

With unique patient IDs, each patient's medical records can be located across a distributed network. However, the problem of data and system security must be addressed. Each server that is part of the system must be an authorized participant in the medical information network. Otherwise, unauthorized individuals could gain access to others' private information. Thus, the system must have a certification and authorization mechanism to insure system integrity.

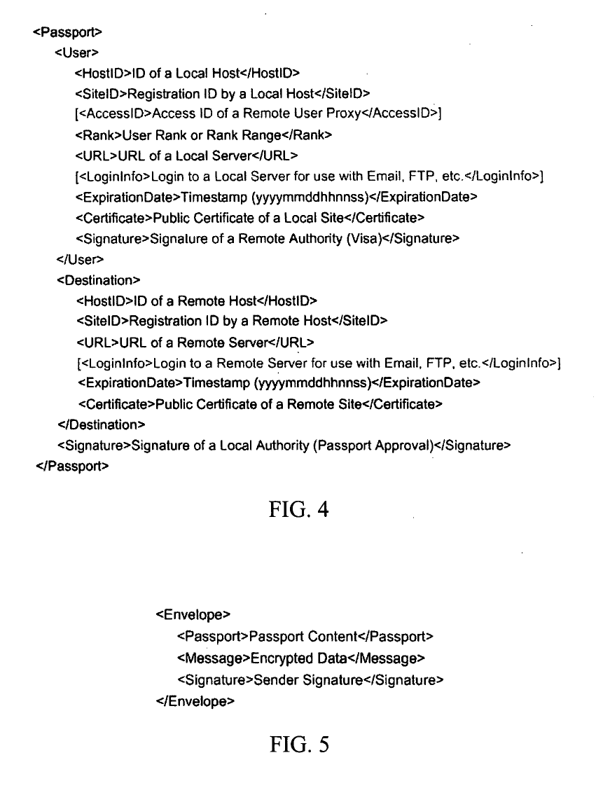

In order to provide for secure authentication and data security between servers, the present invention utilizes “Passports” and “Visas” to facilitate the exchange of data between servers within the system. A passport is a convenient way to authenticate remote communication participants, especially those who do not share the same local certification authority. A passport is an authentication mechanism, similar to a certificate (see FIG. 4). Since security certificates for local patient data servers are generally issued by local certification authorities (such as VeriSign), servers may not be able to authenticate other servers directly. However, they can verify signatures of their local authorities and thus authenticate content of a passport that is relevant for a particular transaction.

For example, someone who requests remote PHI data is interested in the authentication of the destination data of a passport, which is guaranteed by a signature of a local authority approving the entire passport. A public certificate of a remote site enclosed in a passport is used to encrypt the message data of a request. The responder to a request or recipient on the other hand is interested in authentication of user data of a passport, which is guaranteed by a signature of a recipient's authority that locks the user data block. A public certificate of the user data block is used to verify the message signature (see FIG. 5 Message).

The recipient has to have a private key of a key pair, in which the public key was used to encrypt the message. The public key is provided in a passport within a destination data block. Then the public key received in the data block is used to verify an envelope signature. Positive verification proves authenticity of a message. From that point the recipient may start interpretation of a message. If the passport includes an AccessID element, which represents a local account to be used as a proxy, then that account rank and other rights are used to handle the request. Otherwise the rank provided in a passport is used as a valid role for handling data. However, the role will have read-only rights, unless the originating site is registered with the remote site as a trusted site.

This process is further illustrated in FIG. 9. In order to request a passport, a Patient Data Server in Region A (PDS A) 90 must send an application to its Region A Indexing and Network Management Server (INMS A) 92. The INMS A server 92 verifies that the requesting party server is authorized on the network, and creates a passport with a user data block (FIG. 4). An authenticated request for a visa containing the newly created passport is then sent to a remote Region B INMS server 94. An example of a visa can be seen in FIG. 4. The “<Destination>” block provides a description of the remote site, and is signed by the remote site, using a digital signature (visa signature). The local server can now use this electronic document to access remote information from data servers under the regional authority of the signing remote indexing server.

As described herein, the present systems utilizes “passports” and “visas”, which are analogous to documents allowing cross-border access and travel. Passports identify individuals according to a document that all countries accept by virtue of a treaty. Many countries will not admit a traveler without a visa from the country of entry. In the same way, two servers are able to send information back and forth by using mutually agreed upon documents. Each server has a passport issued by a local INMS, which is a trusted issuer of passports according to prior agreements subject to authentication. When one server has found another server, it sends a visa request containing the applicant's passport. The responding server independently verifies the requesting server and sends back the passport with the appropriate “stamps,” which in this case is a digital signature. Now all parties to the transaction are fully informed of their bonafides and data can be exchanged with complete security.

The remote INMS server 94 verifies the request for a visa, completes the passport. If a remote site uses proxy accounts, an AccountID is added otherwise user ranks are also validated. A destination data block is also added at that step. Then the user data block is signed and an authenticated reply is sent back to the requesting INMS server 92. After verification of a visa issuer, the passport is signed by a local INMS 92 and sent back to the requesting PDS A 90, which caches the passport. The patient data server is now enabled to call a remote site for data or service.

The purpose of the passport/visa mechanism is to allow a patient data server, which is the server presently being used by the physician in charge of treating the patient, to call a remote server for data or service. The present invention overcomes deficiencies in prior art systems because it requires no pre-existing account on the remote server, so the network is self-organizing. Connections are enabled only as required, yet the connections are ubiquitous.

In order to request a passport, a patient data server (PDS) has to send an application to its regional indexing and network management server (INMS). The regional INMS verifies the requesting party PDS and creates a passport with user data block (FIG. 4 Passport for remote data exchange). An authenticated request for a visa containing the newly created passport is then sent to a remote INMS. A remote INMS verifies a request for a visa and completes the passport. If a remote site uses proxy accounts, an AccountID is added, otherwise user ranks are validated. A destination data block is also added at that step. Then the user data block is signed and an authenticated reply is sent back to the requesting INMS. After verification of a visa issuer, the passport is signed by a local INMS and sent back to the requesting PDS, which caches the passport. The patient data server is now enabled to call a remote site for data or service.

The message structure and passport are the same for requests and responses, although the verification process is slightly different. In a reply, the process is reversed. The envelope signature is made with the private key of a remote site, which is the companion key to the public key contained by a public certificate in the destination data block. The message encryption on the other hand is made with a public key contained by a public certificate in the user data block.

Each patient data server (PDS) that is registered with a local authority server can request a passport to a specific site or a collection of passports to all or subset of sites that maintain data of a specific patient or entity. Passports are cached by patient data servers for a certain period of time for re-use, but after their expiration they must be re-requested again from a local authority.

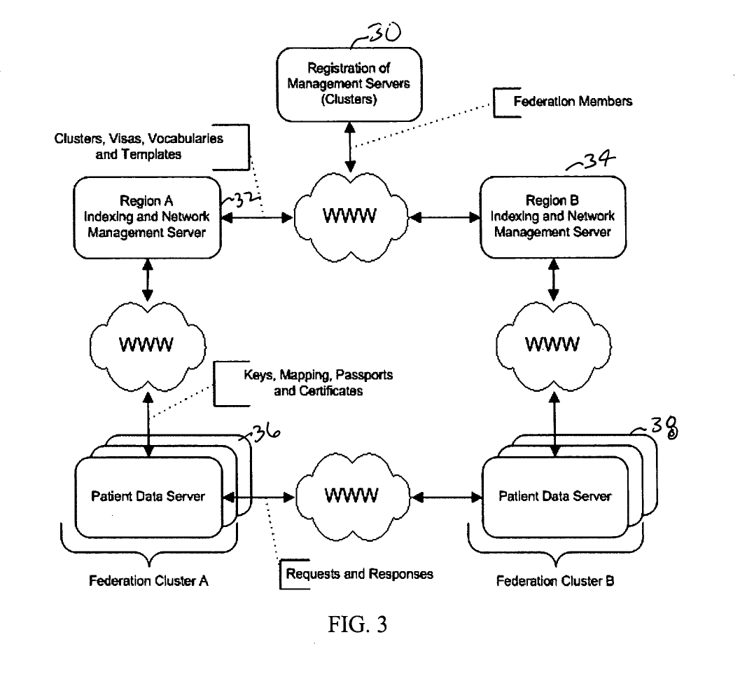

FIG. 3 illustrates a federated system operating according to one embodiment of the present invention. A Central Registration Server (CRS) 30 maintains up-to-date URLs and public key certificates for each indexing server in the system. A new regional Indexing and Network Management server (INMS) 32, 34 must register with the CRS 30 to be visible to other members of a federation. During the registration process, the credentials of a new member server must be thoroughly verified before allowing the server to become a member of a federation. Once approved, a new server becomes a full member of a federation and becomes a local authority with all rights to register patient data servers 36, 38, issue their certificates, approve visas, issue passports and maintain vocabularies and data indexes. Data indexes consists of globally unique identifiers, data signature patterns (classification features) and URLs of systems maintaining the data.

A new patient data server (PDS) 36, 38 must register with a local indexing server or local authority to become a member of a federation. The registration process requires thorough verification of a candidate in a similar manner as done by the central server for indexing servers. Once registered, the patient data server can start communicating with other members of a federation. In order to request data from a remote system, the patient data server (PDS) must identify a patient either by collecting patient demographics via registration forms or by acquiring PHI from a demographics server entered and made available by a patient (as shown in FIG. 1). If demographic data is entered via registration forms, it may be necessary to obtain access ID formats from sites that might have this patient data. Formats can be obtained either from a local cache or from a local authority.

Once the necessary information is gathered, an access ID key pair can be calculated (as shown in FIG. 2). The next step is to find servers that have this patient's data and can respond to a specific question (supports a specific request). That information can be obtained from a local authority server, which in turn communicates with all other regional authority servers or a specified group of them to gather the necessary references. As a result the requesting patient data server receives a list of passports and query translation templates, which can be cached for further use within the current visit.

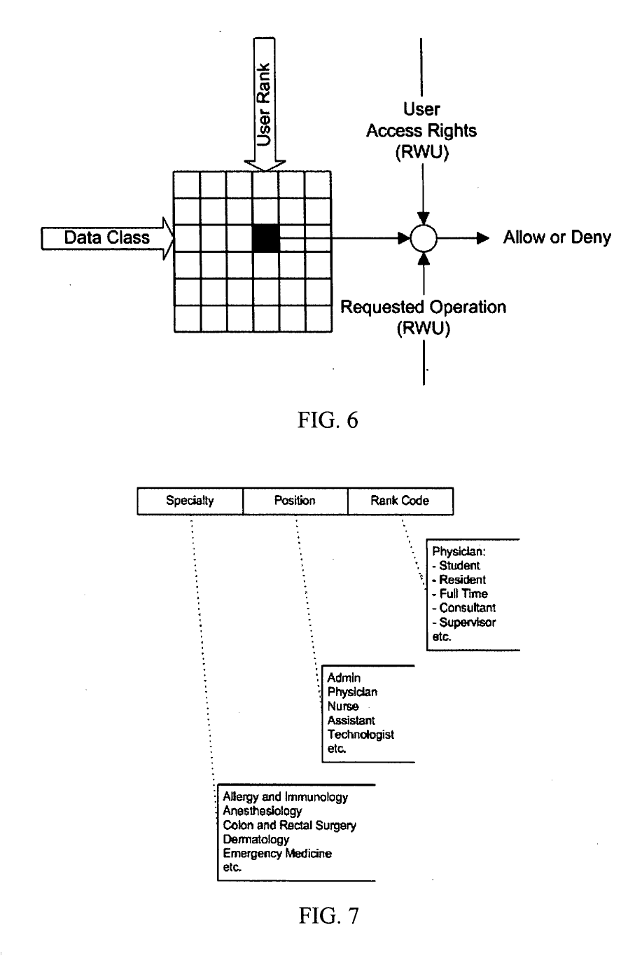

The message data can represent anything from a simple query to a DICOM or HL7 message (medical diagnostic images and medical records, respectively). If the message contains a generic query a remote query operation is performed. A query can request data or service by posting a job request on a bulletin board. In either case, user rights are interpreted regarding each data element. For example, as illustrated in FIG. 6, based on the user's rights, and the requested operation, the request will either be allowed or denied.

To further refine how data is transferred, it is useful to use the concepts of “vocabulary,” “ranks,” and “roles.” A vocabulary contains a flat list of data items handled by a specific patient data server. Each data item of a vocabulary is assigned a specific class such as general, unrestricted clinical, PHI, psychiatric, protected clinical, etc.

A user rank defines in what area and what type of responsibility a person has, e.g. a physician in emergency medicine or a nurse in psychiatry, etc. Ranks are composed of three elements: specialty, position and rank code, as shown in FIG. 7. A specialty relates to any medical specialty group such as Emergency Medicine or any other related specialty such as IT, administration, etc. A position defines a role classification within a specialty such as physician, nurse, etc. A rank code defines an experience level and relationship to the institution, e.g. student, resident, full time, etc. All elements are coded and combined into a single number. Coding of each element can rely on local regulations, because interdependencies are mitigated during initial registration of a server with a local authority. Translations of ranks or references to proxies are imbedded in passports and can be used by requested servers as local ranks or references. Global acceptance of coding could be convenient, but may not be feasible.

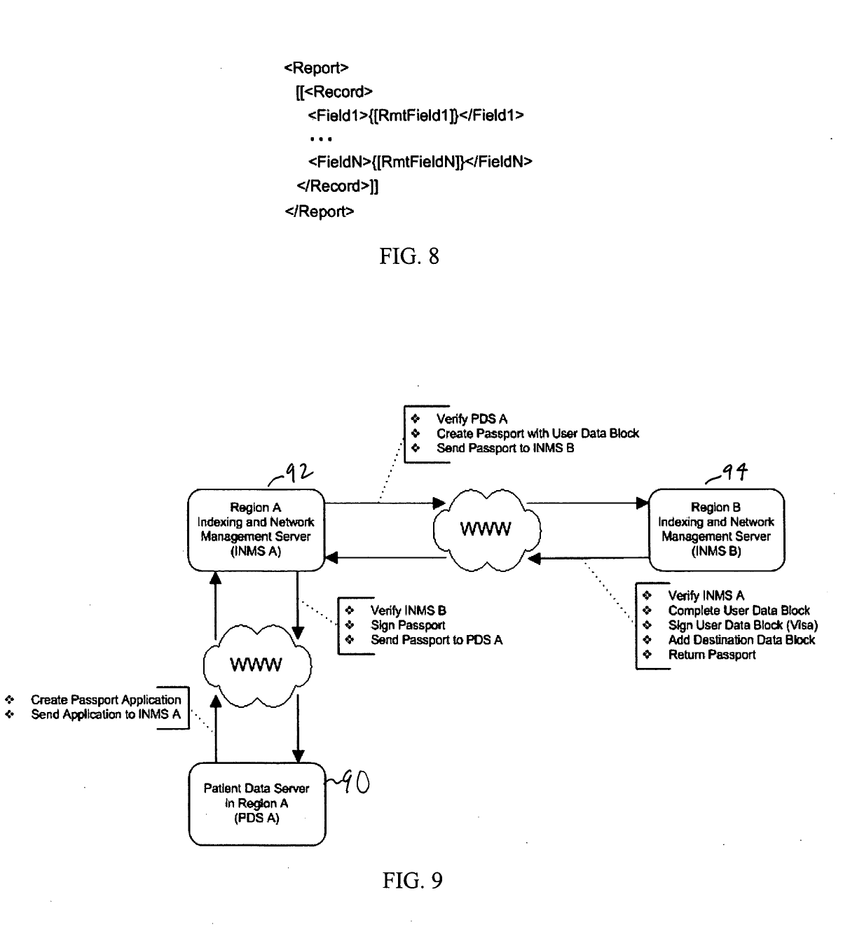

Once the data is retrieved it needs to be translated into the vocabulary of a requestor system. That process is performed utilizing data translation templates, as illustrated in FIG. 8. A translation template is a XML object, wherein the tags represent a requestor vocabulary while text values in curly-square brackets {[ . . . ]} represent a remote server vocabulary. Double square brackets delimit repetitions to be removed from a final report. By using translation templates, different server vocabularies can be automatically translated during data retrieval.

As described herein, the remote access architecture of the present invention simplifies the task of creating point-to-point communications between any pair of servers in a federation of servers that will likely contain thousands of servers. The routing is established as needed on a per transaction basis, and security is maintained even with the use of the Internet. This eliminates the need for special network appliances, or the standardization of a Grid network, or preconfigured point-to-point protocols such as a Virtual Private Network (VPN) that requires each server to have a VPN for each of the other servers.

This federation technology allows local control of data access policies and thus constitutes a true federation of individual entities that can participate on their own terms and conditions. The need for complex contractual agreements between parties, is totally avoided. Participants are asked to grant no more privileges than they allow to their own members, while the present system of passports, visas and authenticating authorities enables the responder to judge the qualifications of the requestor.

As described herein, the present architecture facilitates general “requests” for patient information from remote servers. The indexing servers may maintain a list of patient IDs located in associated patient data servers. This facilitates quick searching, even across a distributed network. Also, since the requests are not direct “queries” of remote databases system and data integrity are preserved. The requests are read-only, so the remote servers only provide a copy of the underlying data. Moreover, each request can be logged by both the requesting and responding server. This data logging can be used to comply with local health information privacy requirements.

When the data is sent, the patient header information can be stripped from the file. If the file inadvertently goes to a third-party, there is no privacy breach since the raw medical information is useless without a connection to a particular patient.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure. More particularly, the present invention may be implemented directly into network interface cards and the like, to provide transparent network and data security and integrity.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, and the display, storage, or communication of results according to the processes of the present invention.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A system for secure remote data access, the system comprising:
at least one data server located in a first region;
at least one data server located in a second region;
a first indexing and network management server providing authentication services for the at least one data server located in the first region;
a second indexing and network management server providing authentication services for the at least one data server located in the second region; and
a central registration server providing authentication services to the first and second indexing and network management servers, including maintaining valid public key certificates for each indexing and management server;
wherein the at least one data server in the first region registers with the first indexing and network management server, and wherein the at least one data server in the second region registers with the second indexing and network management server;
wherein when a data server in the first region requests information on a specific subject from other data servers in the system, the first indexing and management server locates any remote data servers having information on the subject, and provides an authorization passport for the at least one data server to access information on the remote data servers, the authorization passport verifying that the data server in the first region has been authenticated by the first indexing and management server, and that the first indexing and management server has been authenticated by the central registration server; and
wherein the remote data servers provide the requested information on the specific subject to the data server in the first region.

2. The system of claim 1, wherein the authorization passport includes a user data block, and is sent to the second indexing and network management server, which verifies that the first indexing and network management server is authorized on the system, and the second indexing and management server then signs the authorization passport.

3. The system of claim 2, wherein the signed passport authorization is cached for a predetermined period of time.

4. The system of claim 3, wherein the requested information is identified by a unique Access ID and a unique Verify ID, the Access ID and Verify ID are generated as cryptographic hashes of ASCII strings of personal identifying data, and wherein each indexing and management server maintains an index of Access ID and Verify ID pairs for information stored on authenticated data servers in its region.

5. The system of claim 4, wherein the requested information is transferred using a standard vocabulary to facilitate translation between different data storage systems.

6. The system of claim 5, wherein each data server assigns a rank to each user of the system, a rank defining a data authorization classification level for each user, such that different users are allowed to access different levels of information.

7. The system of claim 4, wherein the requested information is translated between systems using an XML object translation template to translate between vocabularies of different data servers.

8. The system of claim 1, wherein a user can enter and maintain personal information in a data server.

9. The system of claim 1, wherein the system includes a plurality of regional indexing and management servers, and each regional indexing and management server authenticates a plurality of local data servers.

10. The system of claim 4, wherein each request for information is logged to comply with privacy regulations.

11. The system of claim 10, wherein any personal identifying information is removed from any data sent from a remote data server.

12. A method for secure remote access to confidential data located on remote data servers, the method comprising:
authenticating each data server in a system with a regional indexing and management server;
authenticating each regional indexing and management server to a central registration server;
storing indexes to information stored in each regional indexing and management server for each data server in its respective region;
requesting information from remote data servers from a local data server;
locating remote data servers having the requested information;
generating an authorization passport from a local indexing and management server;
sending the authorization passport to each remote indexing and management server of the remote data servers having the requested information, wherein each remote indexing and management server authenticates the passport authorization;
providing the authorization passport to the remote data servers having the requested information; and
sending the requested information to the local data server.

13. The method of claim 12, wherein the authorization passport includes a user data block, and is sent to the remote indexing and network management servers, such that each remote indexing and network management server verifies that the local indexing and management server is authorized on the system, and the remote indexing and management serves then sign the respective authorization passports.

14. The method of claim 13, wherein each signed passport authorization is cached for a predetermined period of time by the local data server.

15. The method of claim 14, wherein the requested information is identified by a unique Access ID and a unique Verify ID, the Access ID and Verify ID are generated as cryptographic hashes of ASCII strings of personal identifying data, and wherein each indexing and management server maintains an index of Access ID and Verify ID pairs for information stored on authenticated data servers in its region.

16. The method of claim 15, wherein the requested information is transferred using a standard vocabulary to facilitate translation between different data storage systems.

17. The method of claim 16, further comprising assigning a rank to each user of the system, a rank defining a data authorization classification level for each user, such that different users are allowed to access different levels of information.

18. The method of claim 17, further comprising translating the requested information between systems using an XML object translation template to translate between vocabularies of different data servers.

19. The method of claim 12, wherein a user can enter and maintain personal information in a data server.

20. The method of claim 12, wherein the system includes a plurality of regional indexing and management servers, and each regional indexing and management server authenticates a plurality of local data servers.

21. The method of claim 15, further comprising logging each request for information to comply with privacy regulations.

22. The method of claim 21, further comprising removing any personal identifying information from the requested data before sending any data from a remote data server.

23. A method for locating and accessing patient medical records located on remote data servers in a networked computer system, the method comprising:
authenticating each data server in the system with a regional indexing and management server;
authenticating each regional indexing and management server with a central registration server;
creating an Access ID and a Verify ID for each patient in the system, the Access ID and the Verify ID are generated as cryptographic hashes of ASCII strings of personal identifying data, such each Access ID and Verify ID pair is unique for each patient;
storing indexes to patient medical records stored in each regional indexing and management server for each data server in its respective region, wherein the indexes can be searched by the Access ID and the Verify ID of each patient;
requesting remote patient medical records from remote data servers at a local data server;
generating an authorization passport for the local data server at a regional indexing and management server;
locating the requested remote patient medical records based on the stored indexes at each regional indexing and management server;
sending an authorization passport to each regional indexing and management server having indexes to the requested remote patient medical records;
signing the authorization passports at each regional indexing and management server; and
sending the requested patient medical records from each remote data server to the local data server, based on the signed authorization passport.

24. The method of claim 23, wherein each signed passport authorization is cached for a predetermined period of time by the local data server.

25. The method of claim 24 wherein the requested patient medical records are transferred using a standard vocabulary to facilitate translation between different data storage systems.

26. The method of claim 25, further comprising assigning a rank to each user of the system, a rank defining a data authorization classification level for each user, such that different users are allowed to access different levels of patient specific information.

27. The method of claim 26, further comprising translating the requested patient medical records between systems using an XML object translation template to translate between database terminology of different data servers.

28. The method of claim 27, wherein a user can enter and maintain personal information in a local data server, and can set permission access rights for confidential medical records.

29. The method of claim 23, wherein the system includes a plurality of regional indexing and management servers, and each regional indexing and management server authenticates a plurality of local data servers.

30. The method of claim 23, further comprising logging each request for a patient's medical records to insure each request complies with privacy regulations.

31. The method of claim 30, further comprising removing any personal identifying information from the requested medical records before sending any data from a remote data server.
